(19) United States
(12) Patent Application Publication
(10) Pub. No.: US 2011/0251887 A1
(43) Pub. Date: Oct. 13, 2011

(54) METHODS AND APPARATUS FOR IMPROVING CLICK-THROUGH-RATE OF ADVERTISEMENTS LEVERAGING EFFICIENT TARGETING TECHNIQUES

(75) Inventors: Sanjoy Paul, Bangalore (IN); Rajesh Sridharan, Jayalakshmipuram (IN)

(73) Assignee: INFOSYS TECHNOLOGIES LIMITED, Bangalore (IN)

(21) Appl. No.: 12/816,459

(22) Filed: Jun. 16, 2010

(30) Foreign Application Priority Data
Apr. 13, 2010 (IN) 1030/CHE/2010

(51) Int. Cl. G06Q 30/00; G06Q 10/00

(52) U.S. Cl. 705/14.42; 705/14.43

(57) ABSTRACT

A method for optimized selection and rendering of advertisements on various device types of a user is provided. The method enables receiving inferred data related to the user. The inferred data includes static context inferred from user profile information. The user profile information includes static details pertaining to the user. The inferred data further includes dynamic context. The dynamic context is inferred from the user's behavior across multiple communication channels using the various device types of the user. The method further enables short listing advertisements based on the inferred data and applying predetermined rules on the short listed advertisements to select a final advertisement. Finally, the method enables rendering the final advertisement on at least one of the various devices types of the user.

### BACKGROUND OF THE INVENTION

The present invention relates generally towards rendering advertisements on user devices and more specifically to a method and system that facilitates optimized selection and rendering of advertisements on various devices of a user.

With advancements in telecommunications, advertising has become a widely used medium to induce maximum number of users to purchase products and services. Traditional modes of advertising include broadcasting an advertisement to large number of users via mass media such as newspapers, magazines, radio and television. Further, internet is increasingly being used by advertisers to publish advertisements on websites which are frequently accessed by users. Mobile communication terminals are also used by advertisers for delivering advertisements. However, although a large number of users may see the advertisement, only a small percentage of the users actually purchase the product and services. The advertisers, therefore, incur unnecessary expenditure for users who are not likely to purchase the product or service.

To overcome the abovementioned disadvantages, advertisers employ existing techniques to send advertisements to targeted users who are likely to purchase the products and services. Targeted users are typically identified by the advertisers by retrieving user related information from the user's Personal Computer (PC) having a web browser or from user's mobile device. For example, information may include static user attributes such as age, demographic details, education, income etc. obtained from the user's subscription profile for a mobile or internet service. Also, the information may be obtained from the user's web search pattern using user's PC or mobile device having a web browser. The relevant advertisements are, then, rendered on the user's PC or mobile device. Further, the existing techniques employ limited methods to present relevant advertisements to the users.

For example, online advertising solutions enable advertisers to specify keywords and then associate them with stored advertisements. When users perform search using those keywords the respective advertisements are presented to the users along with search results. Certain online advertising solutions also facilitate selection of advertisements based on the website content for better targeting of the advertisement so that relevance is guaranteed. Further, mobile advertising solutions also employ mobile-based searches performed by mobile users to gather behavioral information related to the users to enable better targeting of advertisements on mobile device of the user.

However, the existing technologies do not facilitate rendering targeted advertisements on various devices such as television, Personal Computer (PC) and mobile of the user. Further, the existing technologies do not facilitate retrieving user information related to user behavior and characteristics from various devices dynamically and targeting advertisements using such information. Further, the existing technologies do not support mechanisms to facilitate optimal selection of advertisements which in turn would increase the probability of users responding to the advertisements.

In light of the abovementioned disadvantages, there is a need for a system and method that renders advertisements on various devices i.e. PC, Mobile and TV. Further, there is a need for a system and method that collects information related to user characteristics from the user's behavior across different access channels i.e. PC, mobile and TV and multiple domains i.e. websites, service provider systems, etc. and render targeted advertisements on various devices. In addition, there is a need for a system and method that facilitates efficient advertisement selection techniques.

### SUMMARY OF THE INVENTION

A method for optimized selection and rendering of advertisements on various device types of a user is provided. The method comprises, firstly, receiving one or more inferred data related to the user. The inferred data includes static context inferred from user profile information. The user profile information includes one or more static details pertaining to the user. The inferred data further includes dynamic context. The dynamic context is inferred from the user's behavior across multiple communication channels using the various device types of the user. Secondly, the method comprises short listing one or more advertisements based on the inferred data. The method further comprises applying one or more predetermined rules on the short listed advertisements to select a final advertisement. Finally, the method comprises rendering the final advertisement on at least one of the various devices types of the user.

In an embodiment of the present invention, the one or more static details related to the user comprises at least one of: name, age, gender, address, mobile station integrated services digital network number (MSISDN), occupation details and any other information related to the user. In another embodiment of the present invention, the one or more predetermined rules comprises: selecting advertisements having maximum return on investment, selecting advertisements based on number of times same or similar advertisements is shown to the user, selecting advertisements based on the deadline for rendering advertisements, selecting advertisements based on cost-per-mill, and selecting advertisements based on cost-per-cost. In yet another embodiment of the present invention, the predetermined rules are determined by a communication service provider.

In an embodiment of the present invention, the method further comprises, firstly, receiving user profile information. Secondly, the method comprises receiving one or more campaign attributes. The campaign attributes represent one or more predetermined criteria for categorizing one or more advertisements. The method further comprises comparing the user profile information with the one or more campaign attributes. Further, the method comprises enhancing the user profile information with one or more inferred data related to the user. The method further comprises short listing one or more advertisements based on the enhanced user profile information and applying one or more predetermined rules on the short listed advertisements to select a final advertisement. Finally, the method comprises rendering the final advertisement on at least one of the various devices types of the user. In an embodiment of the present invention, the one or more predetermined criteria for categorizing one or more advertisements comprises categorizing advertisements for: users between a specific age group or users residing in a specific location or users with a specific income range or users with a specific trait or a combination thereof. In an embodiment of the present invention, the one or more predetermined criteria are determined by an advertiser. In another embodiment of the present invention, comparing the user profile information with the one or more campaign attributes comprises identifying one or more advertisements categorized under one or more predetermined criteria that correspond to the user profile information.

In another embodiment of the present invention, the dynamic context is based on data related to at least one of: one or more requests made by the user via the various device types of the user, current location of the user, user's feedback on an earlier advertisement rendered on at least one of the various device types, and the user's response to an advertisement rendered on at least one of the various device types of the user. In yet another embodiment of the present invention, the requests comprise at least one of: browsing a website from a PC, making online purchases using PC, surfing channels in a TV, and making purchases via an IPTV video-on-demand service.

In yet another embodiment of the present invention, the dynamic context is based on data obtained by tracking user's different response to same advertisement rendered on the various device types of the user across the multiple communication channels. In another embodiment of the present invention, the multiple communication channels comprises at least one of: internet, wireless network capable of data exchange such as General Packet Radio Service (GPRS), Enhanced Data for Global Evolution (EDGE), High-Speed Packet Access (HSPA), Evolution Data Optimized (EvDO), Long-Term Evolution (LTE), Worldwide Interoperability for Microwave Access (WiMAX), Wireless Fidelity (WiFi), High Speed digital cable, Direct to Home (DTH) TV and Internet Protocol Television (IPTV) and any other type of over the air wireless network. In yet another embodiment of the present invention, the dynamic context is based on data related to user's rating on an advertisement rendered on the various device types of the user or user's feedback indicating request for an advertisement different from an advertisement rendered on the various device types of the user or combinations thereof.

In an embodiment of the present invention, the method further comprises updating the user profile information with information related to user's preferences and interest areas. In another embodiment of the present invention, rendering the final advertisement on at least one of the various devices types of the user comprises: rendering the advertisements on predetermined space present on web, TV and mobile device portal applications of the user.

An optimized advertisement delivery engine for optimized selection and rendering of advertisements on various device types of a user is provided. The optimized advertisement delivery engine comprises an inference engine configured to infer data related to the user. The inferred data includes static context inferred from user profile information and dynamic context inferred from the user's behavior across multiple communication channels using the various device types of the user. The optimized advertisement delivery engine further comprises an advertisement targeting module configured to short list one or more advertisements based on the inferred data. Furthermore, the optimized advertisement delivery engine comprises an advertisement selection module configured to select a final advertisement by applying predetermined rules on the short listed advertisements for rendering on at least one of the various device types.

In an embodiment of the present invention, the optimized advertisement delivery engine further comprises a data collector module configured to gather data related to the user across the multiple communication channels. In another embodiment of the present invention, the optimized advertisement delivery engine further comprises a metrics and usage database configured to store the gathered data.

In another embodiment of the present invention, the optimized delivery engine further comprises an analytical engine configured to analyze the inferred data to determine at least one of: usage of multiple communication channels, and efficiency of a convergence gateway module. The optimized delivery engine further performs trend analysis on advertisement inventory purchases made by the advertisers. The optimized delivery engine analyzes advertisement campaigns published at predetermined space present on web applications provided on the various device types and generate one or more reports based on the analysis. In an embodiment of the present invention, the various device types comprise at least one of: PC, TV, mobile device and any electronic communication device.

In an embodiment of the present invention, the optimized advertisement delivery engine further comprises an advertisement publisher module configured to receive information related to capabilities and limitations of the various device types. In another embodiment of the present invention, the optimized advertisement delivery engine determines an appropriate format for rendering the final advertisement on the various device types and renders the advertisement on one or more predetermined space present on web applications provided on the various device types. In an embodiment of the present invention, the device capabilities and limitations include at least one of: screen size of the device and format supported by the device.

A system for optimized selection and rendering of advertisements on various device types of a user is provided. The system comprises an application module comprising one or more applications. The application module is configured to facilitate creating one or more campaign attributes. The campaign attributes represent one or more predetermined criteria for categorizing one or more advertisements. The system further comprises a multi channel optimized advertisement (MCOA) server in communication with the one or more applications of the application module. The MCOA server comprises an optimized advertisement delivery engine configured to short list one or more advertisements based on a comparison of user profile information and the one or more campaign attributes. Further, the optimized advertisement delivery engine is configured to short list one or more advertisements based on one or more inferred data related to the user. The inferred data includes static context inferred from user profile information and dynamic context inferred from the user's behavior across multiple communication channels using the various device types of the user. The optimized advertisement delivery engine selects a final advertisement by applying predetermined rules on the short listed advertisements for rendering on at least one of the various device types.

In an embodiment of the present invention, the MCOA server further comprises an inventory management module configured to facilitate an advertiser to locate one or more predetermined space present on web applications provided on the various device types via an inventory management application in the application module. Further, the MCOA server facilitates the advertiser to purchase the one or more predetermined space via the inventory management application. In another embodiment of the present invention, the MCOA server further comprises a campaign management module configured to facilitate an advertiser to create one or more campaign attributes via a campaign management application in the application module. Further, the MCOA server facilitates an advertiser to publish advertisement campaigns on the predetermined space present on web applications provided on the various device types via the campaign management application.

In an embodiment of the present invention, wherein the MCOA server further comprises a user profile management module configured to maintain one or more information related to user comprising name, age, gender, address, mobile station integrated services digital network number (MSISDN), occupation details or any other information related to the user. Further, the MCOA server updates the one or more information with information related to user preferences and interest areas via a user profile management application.

In another embodiment of the present invention, the system further comprises a campaign management database configured to store the one or more campaign attributes. In another embodiment of the present invention, the system further comprises an inventory management database configured to store information related to the one or more predetermined space. In yet another embodiment of the present invention, the system further comprises a user profile database configured to store the information related to the user.

In an embodiment of the present invention, the system further comprises a data access module configured to receive data from the one or more modules of the MCOA server and store the data in a database server. In another embodiment of the present invention, the system further comprises a convergence gateway module configured to analyze requests made by the user via the various device types over one or more communication channels. The convergence gateway module further determines capabilities and limitations of the various device types. Furthermore, convergence gateway module defines a set of symbols and rules for creating a markup to present advertisement on the various device types and transcode advertisement media from one encoding format to another encoding format supported by the various device types.

In an embodiment of the present invention, the optimized delivery engine further comprises an advertisement targeting module configured to short list one or more advertisements based on a comparison of user profile information and the one or more campaign attributes. Further, the optimized delivery engine is configured to short list one or more advertisements based on inferred data related to the user. In another embodiment of the present invention, the optimized delivery engine further comprises an advertisement selection module configured to select a final advertisement by applying predetermined rules on the selected advertisements.

### BRIEF DESCRIPTION OF THE DRAWINGS

FIG. 1 is a block diagram of a system that facilitates optimized selection and rendering of advertisements on various devices of a user, in accordance with an embodiment of the present invention.

FIG. 2 illustrates a detailed block diagram of an optimized advertisement delivery engine, in accordance with an embodiment of the present invention.

FIG. 3 is a flowchart illustrating a method that facilitates optimized selection and rendering of advertisements on various devices of a user, in accordance with an embodiment of the present invention.

FIG. 4 is a flowchart illustrating a method that facilitates optimized selection and rendering of advertisements on various devices of a user, in accordance with an embodiment of the present invention.

### DETAILED DESCRIPTION

A method and system for optimized selection and rendering of advertisements on various devices i.e. PC, TV and mobile phones of a user is described herein. The invention provides for a method and system that gathers information related to user behavior and characteristics from various devices and renders targeted advertisements to the user based on the gathered information. Further, the invention provides for a method and system that facilitates rendering relevant advertisements on the various devices by optimally selecting advertisements from multiple advertisements employing one or more predetermined rules.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

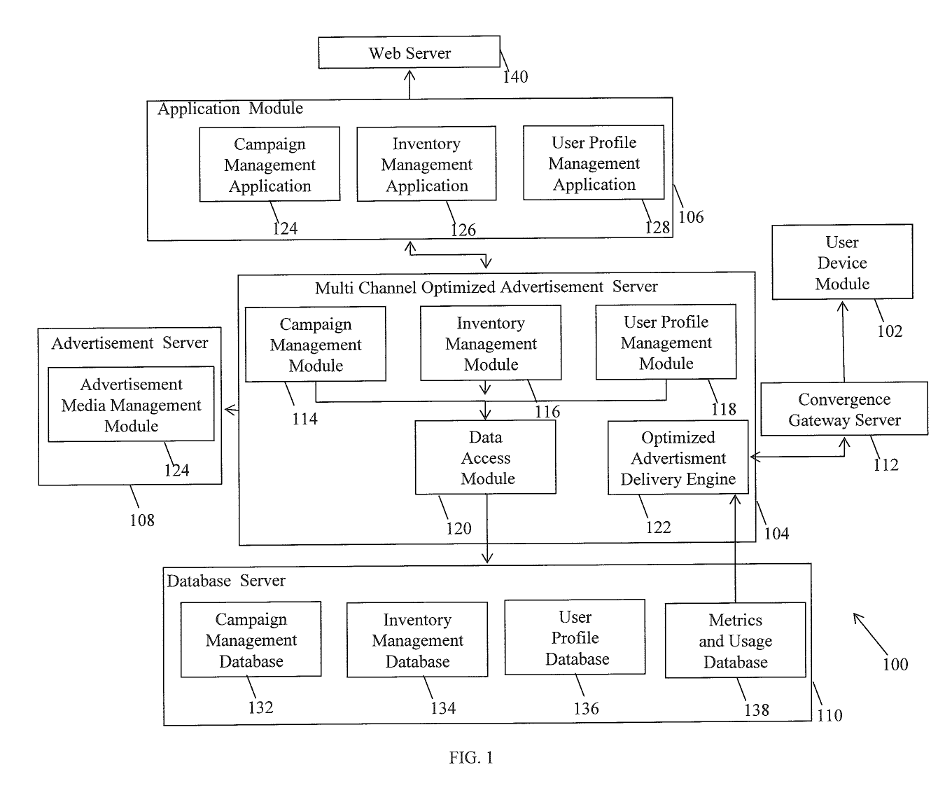

FIG. 1 is a block diagram of a system 100 that facilitates optimized selection and rendering of advertisements on various devices of a user, in accordance with an embodiment of the present invention. In various embodiments of the present invention, the system 100 comprises a user device module 102, a multi channel optimized advertisement (MCOA) server 104, an application module 106, an advertisement server 108, a database server 110, and a convergence gateway server 112.

User device module 102 comprises various electronic communication devices which may be used by one or more user to access various applications or services using multiple communication channels. The various electronic communication devices include TV, PC, mobile phones and other electronic communication devices which are used by the user to access various web-based, mobile-based, and television-based applications. Examples of multiple communication channels may include internet, wireless network capable of data exchange such as general packet radio service (GPRS), enhanced data for global evolution (EDGE), high-speed packet access (HSPA), evolution data optimized (EvDO), long-term evolution (LTE), worldwide interoperability for microwave access (WiMAX) Wireless Fidelity (WiFi), high speed digital cable, Direct to Home (DTH) TV, Internet Protocol television (IPTV) and any other type of over the air wireless network. Examples of devices may include desktop or laptop with access to internet, high end mobile devices capable of exchanging data, open cable application platform (OCAP)/enhanced TV binary interchange format (EBIF) based digital cable TV, direct to home (DTH) TV and any IPTV based system. Examples of mobile phones may include cellular phones, such as, high-tech computer corporation (HTC) phones, Nokia N95, Blackberry, personal digital assistants (PDA), enterprise digital assistants (EDA) and any other handheld computing devices.

In various embodiments of the present invention, various advertisements are rendered on the user device module 102. In an embodiment of the present invention, web applications such as websites, portals etc. are accessible through the user's PC via the internet or are provided by the user's communication service provider (CSP). The web applications have predetermined space where advertisements may be displayed to the user when the user accesses the web application. In another embodiment of the present invention, IPTV portal applications are provided to the user by the user's CSP via his IPTV set-top-box. The IPTV portal applications have predetermined space where advertisements may be displayed to the user when the user accesses his IPTV portal application. In yet another embodiment of the present invention, mobile portal applications are available to the user on his mobile phone which is either provided by the user's CSP or is accessible via internet. The mobile portal applications have predetermined space where advertisements may be displayed to the user when the user accesses his mobile phone portal application. The user device module 102 receives the relevant advertisements for display via the MCOA sever 104.

The MCOA server 104 comprises one or more modules such as the campaign management module 114, an inventory management module 116, a user profile management module 118, a data access module 120 and an optimized advertisement delivery engine 122. The one or more modules of the MCOA server 104 operate in conjunction with the application module 106, the advertisement server 108 and the database server 110.

The application module 106 comprises a campaign management application 124, an inventory management application 126, and a user profile management application 128. In an embodiment of the present invention, the application module 106 may be provided as a client application. In another embodiment of the present invention, the application module 106 may be provided as a server application on a web server 140. The server may be a Tomcat web server which may be operating via an application server such as a Windows 2003 server.

The advertisement server 108 may be a web server that facilitates advertisers to store advertisements which is to be used in online marketing. The advertisement server 108 may be a local advertisement server or a remote advertisement server. The local advertisement server serves a single publishing website. The remote advertisement server may serve advertisements to multiple publishing websites. The remote advertisement server delivers advertisements from a central source so that advertisers and publishers owning the multiple publication websites can track distribution of online advertisements. Examples of publishing sites include yahoo, rediff, etc.

In an embodiment of the present invention, the advertisement server 108 comprises advertisement media management module 124 which facilitates the advertiser to upload advertisements in the publishing websites. The advertisement media management module 124 provides necessary data to the MCOA server 104 for calculation of the click-through-rate (CTR). CTR is determined on the basis of the users clicking on the advertisement published on the user device module 102. Further, the advertisement media management module 124 facilitates the advertiser to publish/render advertisement campaigns via the campaign management module 114.

In an embodiment of the present invention, the campaign management module 114 is a software module that comprises various graphic user interface (GUI) tools for publishing advertisement campaigns on PC, TV and mobile phones. The advertisement campaign may be defined as series of advertisement messages that share a single idea and theme. The campaign management module 114 facilitates creation, modification, and definition of advertisement publications on the user's PC, TV and mobile phones. Further, the campaign management module 114 facilitates associating appropriate advertisement media stored in the advertisement server 108 to PC, TV and mobile phone of the user. Furthermore, the campaign management module 114 facilitates the advertiser to create one or more campaign attributes for delivering advertisements to targeted users. The campaign attributes represent predetermined criteria for categorizing advertisements. In an exemplary embodiment of the present invention, the predetermined criteria may include categorizing advertisements for users between the age group of 25 to 35 years, for users living in a particular city, users within a specified income range, users with a specific trait or a combination of the aforementioned conditions.

In an embodiment of the present invention, the campaign management module 114 facilitates advertisers to define and publish advertisement campaigns using the campaign management application 124. The campaign management application 124 is a software application that enables advertisers to define and publish advertisement campaigns using predetermined space/advertisement inventory available on various web applications. The campaign management module 114 integrates with the inventory management module 116 to enable association of the advertisement inventory to the advertisement campaigns. Advertisement inventory is the advertising space that various publishers provide on web, TV or mobile portals of the user for the advertiser to purchase. For example, a time slot in a TV program may be a kind of TV advertisement inventory. Similarly, a physical location at the bottom of a web page represents advertisement inventory.

The inventory management module 116 is a software module that facilitates the advertisers to purchase advertisement inventory across the PC, TV and mobile phone applications using the inventory management application 126. In an embodiment of the present invention, the inventory management application 126 is an application that provides a search feature to the advertiser which facilitates the advertiser to locate available advertisement inventory across various devices i.e. PC, TV and mobile phone of the user. The inventory management application 126 enables an advertiser to select and purchase advertisement inventory from the advertisement slots available in the portal applications.

The inventory management module 116 facilitates the CSPs to define various forms of advertisement inventory to support multiple communication channels across PC, TV and mobile phone of the user. The different forms include portal advertisement inventory, mobile advertisement inventory and TV advertisement inventory having different capabilities and limitations. In an embodiment of the present invention, the inventory management module 116 maintains status of the advertisement inventory and facilitates the advertiser to search for the advertisement inventory using the inventory management application 126. In another embodiment of the present invention, the inventory management module 116 facilitates the advertiser to organize the advertisement based on taxonomy via the inventory management application 126.

In an embodiment of the present invention, the inventory management module 116 facilitates handling unsold inventory. In another embodiment of the present invention, the inventory management module 116 facilitates forecasting based on previous purchase patterns of multiple advertisers across multiple communication channels. In yet another embodiment of the present invention, the inventory management module 116 provides capability to associate target users based on categorization of the advertisement inventory. Further, the inventory management module 116 also permits integration with third-party advertisement inventory associated with organizations outside the CSP.

The user profile management module 118 is a software module which facilitates updating basic profile information of the user using the user profile management application 128. The basic profile information is provided by the CSP and includes name, contact details of the user. In an embodiment of the present invention, the user profile management module 118 may be integrated with the customer relationship management (CRM) system in the CSP's system for providing the basic profile information of the user. The basic profile information is further updated, with other information related to preferences and interest areas of the user for receiving advertisements from advertisers on the user device module 102. The preferences and interest areas facilitate to identify the advertisements that the user would like to see and the advertisements that the user would not like to see.

The data access module 120 is a software module that retrieves data from the campaign management module 114, inventory management module 116 and user profile management module 118 and stores in the database server 110. The data access module 120 facilitates encapsulating data retrieved from each of the abovementioned modules for storing the data in corresponding databases in the database server 110.

The database server 110 further comprises a campaign management database 132, an inventory management database 134, a user profile database 136, and a metrics and usage database 138. In an embodiment of the present invention, the campaign management database 132 stores information related to the advertisement campaigns. The information may include advertiser details, product details, campaign details and campaign attributes. In an embodiment of the present invention, the inventory management database 134 stores a list of advertisement inventory i.e. PC-based web portal slots, mobile portal slots, TV portal slots available in predetermined spaces associated with the publishing websites. In an embodiment of the present invention, the user profile database 136 facilitates storing the basic and updated user profile information. In an embodiment of the present invention, the metrics and usage database 138 stores data received by one or more modules of the optimized advertisement delivery engine 122. In an embodiment of the present invention, the database server 110 may be a relational database management system such as Oracle 10 g, standard query language (SQL) etc. operating via a windows 2003 server.

The optimized advertisement delivery engine 122 analyzes data stored in various databases of the database server 110. In an embodiment of the present invention, the optimized advertisement delivery engine 122 analyzes data related to the user behavior across the multiple communication channels for selecting relevant advertisements and rendering on the user device module 102. In another embodiment of the present invention, the optimized advertisement delivery engine 122 analyzes static details of the user for selecting relevant advertisements and rendering on the user device module 102. In yet another embodiment of the present invention, the optimized advertisement delivery engine 122 analyzes device related data associated with the user device module 102. The optimized advertisement delivery engine 122 receives data from the user device module 102 and renders relevant advertisements to targeted users on the user device module 102 via the convergence gateway server 112.

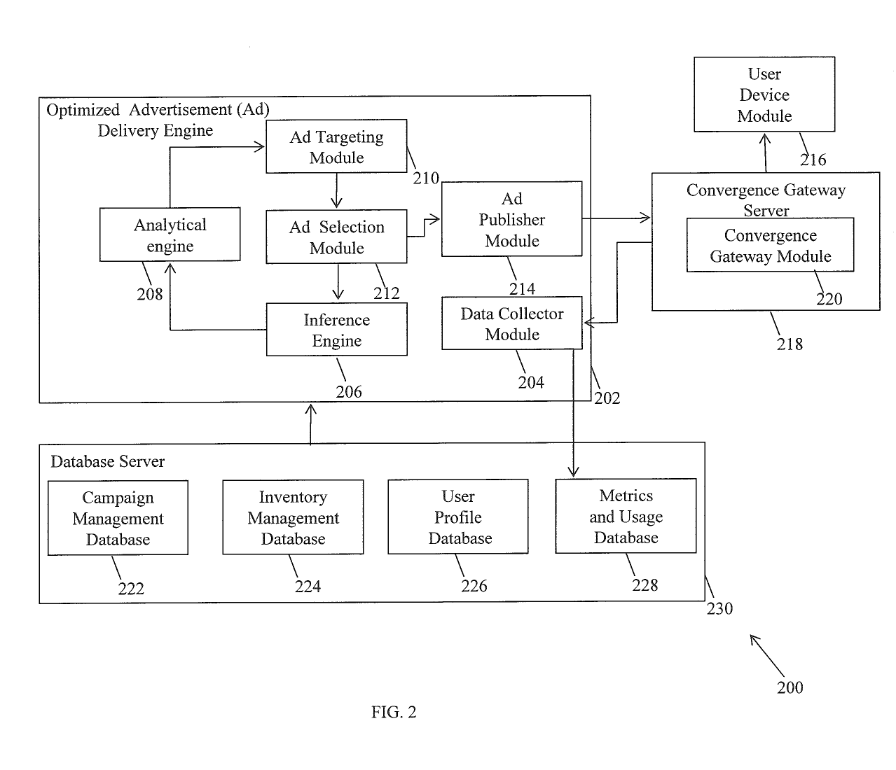

FIG. 2 illustrates a detailed block diagram of the optimized advertisement delivery engine 202, in accordance with an embodiment of the present invention. In various embodiments of the present invention, the optimized advertisement delivery engine 202 comprises a data collector module 204, an inference engine 206, an analytical engine 208, an advertisement targeting module 210, an advertisement selection module 212 and an advertisement publisher module 214. The optimized advertisement delivery engine 202 receives user data from the user device module 216 via the convergence gateway server 218.

The convergence gateway server 218 comprises a convergence gateway module 220 which is a software module that analyzes requests made by the user via the various devices such as PC, TV and mobile phone over the multiple communication channels. The requests may include browsing a website from a PC, making online purchases using the PC, surfing channels in a TV or making purchases via an IPTV video-on-demand service. Further, the convergence gateway module 220 determines device capabilities or limitations from the requests. The capabilities and limitations of the devices include information relating to screen size of the devices, format supported by the devices etc. The convergence gateway module 220 further defines a set of symbols and rules for creating a markup to present the advertisement content on the user device module 216. The convergence gateway module 220 further facilitates transcoding advertisement media from one encoding format to another encoding format if a particular device supports only a predefined set of formats for image, audio and video. In an embodiment of the present invention, the convergence gateway server 218 may be a J2EE server. In another embodiment of the present invention, the CSP may provide various other gateways to receive user requests such as wireless application protocol (WAP) gateway, short messaging service (SMS) gateway, interactive voice response (IVR) gateway, and unstructured supplementary service data (USSD) gateway.

In an embodiment of the present invention, the data collector module 204 is a software module that facilitates collecting data related to user's usage of CSP's products and services which includes, but is not limited to, user's purchase history, browsing history etc. from different portal applications via the convergence gateway server 218. In an exemplary embodiment of the present invention, the CSP's network management system may be integrated with the data collector module 204 via the convergence gateway server 218 to gather information regarding how the user is using his mobile services, broadband services and IPTV services. The data represents the user's usage data captured from different portal applications and services used by the user. Further, the data collector module 204 may be integrated with the CSP's billing system to retrieve data pertaining to billing data records of the user for obtaining information regarding the user's purchase patterns. The data collector module 204 stores the data in the metrics and usage database 228.

In another embodiment of the present invention, the data collector module 204 may collect data related to the user's current location and store the data in the metrics and usage database 228. In yet another embodiment of the present invention, the data collector module 204 may collect data related to feedback provided by the user on advertisements rendered on the user device module 216 and store the data in the metrics and usage database 228. In another embodiment of the present invention, the data collector module 216 may collect data related to the user's response on advertisements rendered on the user device module 216 and store the data in the metrics and usage database 228.

The inference engine 206 is a software module that retrieves the data stored in the metrics and usage database 228 and analyzes the data to infer various characteristics of the user. The data includes dynamic data indicating user behavior across multiple communication channels.

In an embodiment of the present invention, the inference engine 206 analyzes the retrieved data to infer data related to user characteristics based on the requests made by the user across the PC, TV, and mobile phone. For example, based on data related to purchases made by the user on the IPTV video-on-demand service, the inference engine 206 analyzes whether the user likes a particular genre i.e. action, comedy etc.

In another embodiment of the present invention, the inference engine 206, analyzes retrieved data to infer user characteristics based on current location of the user. For example, if the user is near a famous book store, advertisement of that particular store may be identified.

In yet another embodiment of the present invention, the inference engine 206 analyzes retrieved data to infer user characteristics based on feedback provided by the user on an earlier advertisement that was rendered on any of the user's device such as PC, TV and mobile phone. The user's feedback may indicate request for an advertisement which is different from the advertisement that is rendered on the user's device. For example, an advertisement of a car may be rendered on the user's device. The user may not be interested in car advertisements since he has recently bought a car and may be interested in a vacation instead. The user can provide a feedback on the advertisement indicating ‘vacation places’ for future advertisements. Further, the user may provide the feedback on the TV channel and the vacation advertisement may be rendered on his TV, mobile phone and PC.

In another embodiment of the present invention, the user's feedback may indicate rating on advertisements rendered on the user's device. For example, rating ‘3’ on a scale of 1 to 10 for a particular advertisement and rating ‘9’ on a scale of 1 to 10 for another advertisement.

In another embodiment of the present invention, the inference engine 206 analyzes retrieved data to infer information related to the user characteristics by analyzing information related to the user's response to the advertisements rendered on the user device module 216. For example, the user may not buy a vacation package advertised by the user on a travel website in the user's PC, while the user is at work. Further, the user may not respond when the same travel website sends the user, a promotion of the same vacation package at 20% discount on his mobile phone, while the user is on his way back home. The user may respond when the same travel website sells the same package at 40% discount on the user's TV when he is at home and watching an IPL match. The user's response indicates the user's cost preferences.

In another embodiment of the present invention, the inference engine 206 retrieves user profile information stored in the user profile database 226 and infers user characteristics by analyzing the user profile information. The user profile information includes static details related to the user.

The analytical engine 208 is a software module which retrieves and analyzes inferred data representing the user characteristics obtained from the inference engine 206. Further, the analytical engine 208 analyzes data related to advertisement inventory obtained from the inventory management database 224, data related to campaigns obtained from campaign management database 222. For example, the analytical engine 208 performs trend analysis on the advertisement inventory purchases made by different advertisers. Furthermore, the analytical engine 208 performs analysis on the published campaigns to measure effectiveness of campaigns. In an embodiment of the present invention, the analytical engine 208 may be integrated with business intelligence systems of the CSP such as data marts or data warehouses for obtaining analytics data related to the user.

In an embodiment of the present invention, the analytical engine 208 facilitates generating multiple reports for service providers, advertisers and advertisement publishers based on the analysis performed. The multiple reports for service providers may include advertisement inventory reports including information related to sold and unsold inventory, advertisement sales effectiveness reports which may aid service providers to optimize advertisement inventory, pricing and advertisement publication reports which may include information related to frequently used multiple communication channels, efficiency of the convergence gateway module 220 and formats for displaying advertisements on the user device module 216. The multiple reports for advertisers include campaign reports which may include information related to published campaign effectiveness, campaign optimization etc. The multiple reports for advertisement publishers may include reports on usage of advertisement inventory.

The advertisement targeting module 210 is a software module that facilitates determining relevant advertisements for delivery to users. In an embodiment of the present invention, the advertisement targeting module 210 facilitates using the inferred data corresponding to the user from the analytical engine 208 for short listing one or more advertisements which are to be delivered. In another embodiment of the present invention, the advertisement targeting module 210 retrieves profile of the user on whose user devices module 216 the advertisement is to be delivered from the user profile database 226. The advertisement targeting module 210 further retrieves the campaign attributes from the campaign management database 222. The advertisement targeting module 210 facilitates comparing the user profile information with one or more campaign attributes to identify advertisements from multiple advertisements. Further, the advertisement targeting module 210 uses the inferred data to short list one or more advertisements from the identified advertisements.

The advertisement selection module 212 is a software module that receives the one or more advertisements from the advertisement targeting module 210. The advertisement selection module 212 applies predetermined rules to select the final advertisement which is to be rendered on the user devices module 216. In an embodiment of the present invention, the predetermined rules may be defined by CSPs of the user. The predetermined rules may be based on metrics such as performance measure e.g. return on investment (ROI), number of times the same advertisement or similar advertisement was shown to the user, deadline for rendering advertisements, pricing models such as cost-per-mill (CPM), cost-per-click (CPC) etc. which are either based on negotiated value or auction.

The advertisement publisher module 214 is a software module that receives the selected advertisement from the advertisement selection module 212. Further, the advertisement publisher module 214 determines an appropriate format to display advertisement content on the user device module 216 based on the device related information received from the convergence gateway module 220 within the convergence gateway server 218.

In an embodiment of the present invention, the advertisement publisher module 214 renders the selected advertisement content on the user device module 216 via the convergence gateway server 218. In an embodiment of the present invention, the CSP may facilitate integration of the optimized advertisement delivery engine 202 with external organizations to enable rendering of advertisements in advertisement inventory defined, owned and managed by the external organizations. In an embodiment of the present invention, the CSP may identify possible interaction points, for example via interactive applications, between the user device module 216 and the respective communication channels. The CSP may render the advertisement content on the advertisement inventory available on the user device module 216 during such interactions.

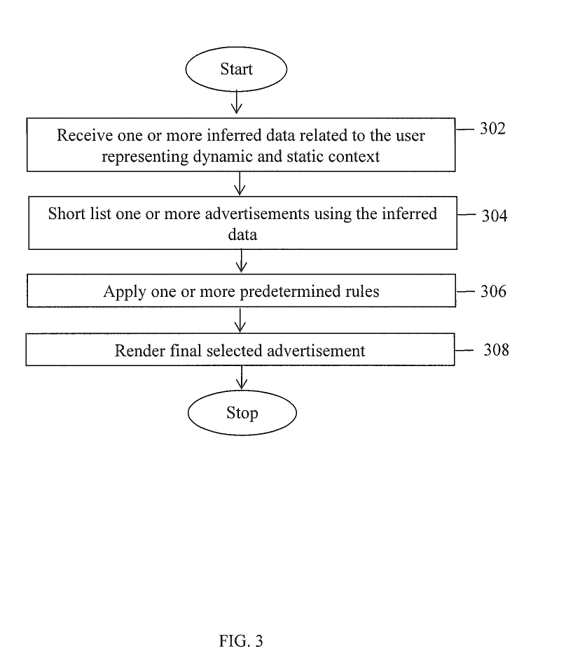

FIG. 3 is a flowchart illustrating a method that facilitates optimized selection and rendering of advertisements on various devices of a user, in accordance with an embodiment of the present invention.

At step 302, one or more inferred data is received. In various embodiments of the present invention, the inferred data facilitates to determine user characteristics. In an embodiment of the present invention, the inferred data includes static context which is obtained by analyzing one or more static details pertaining to the user. The static data may include, but is not limited to, name, age, gender, contact details such as mobile station integrated services digital network (MSISDN) number, city, and occupation details.

The inferred data also includes dynamic context which is obtained by analyzing the user's behavior across multiple communication channels using the various devices. In an exemplary embodiment of the present invention, the dynamic context is based on data related to requests made by the user using the various devices. For example, if the user is found to be requesting for sports related information using his mobile phone or surfing sports channels in TV, the user may be inferred as sports enthusiast. Further, if the user is found to be purchasing thriller movies on the IPTV video-on-demand service, the user may be inferred as a thriller movie enthusiast. In another exemplary embodiment of the present invention, the dynamic context is based on data related to current location of the user. In yet another exemplary embodiment of the present invention, the dynamic context is based on data related to user's feedback on an earlier advertisement rendered on at least one of the various device types. In another exemplary embodiment of the present invention, the dynamic context is based on data related to the user's response to an advertisement rendered on at least one of the various device types, which is tracked dynamically.

At step 304, one or more advertisements are short listed. In an embodiment of the present invention, one or more advertisements may be short listed as targeted advertisements using the inferred data. In an exemplary embodiment of the present invention, advertisements related to sports may be selected from the one or more advertisements if the user is found to be a sports enthusiast. In another exemplary embodiment of the present invention, advertisements related to thriller movies may be selected.

At step 306, one or more predetermined rules are applied on the one or more advertisements. In an embodiment of the present invention, the one or more predetermined rules may be rules defined by the CSP for optimal selection of the final advertisement which is to be rendered on the various devices of the user. In an exemplary embodiment of the present invention, the one or more predetermined rules may include selection of advertisement which may be determined to have maximum return on investment (ROI). In another exemplary embodiment of the present invention, the one or more predetermined rules may be based on cost-per-mill (CPM), cost-per-cost (CPC) etc. In an exemplary embodiment of the present invention, if the sports related advertisement is associated with maximum ROI, it is selected as the final advertisement.

At step 308, final selected advertisement is rendered on the various devices. In an embodiment of the present invention, the final selected advertisement is rendered on the advertisement inventory on any of or all of PC, TV and mobile phone of the user. In an exemplary embodiment of the present invention, the advertisement may be rendered when the user is in an interactive session via his various devices. In another exemplary embodiment of the present invention, the advertisement may be rendered when user's devices are in an active but non-interactive mode.

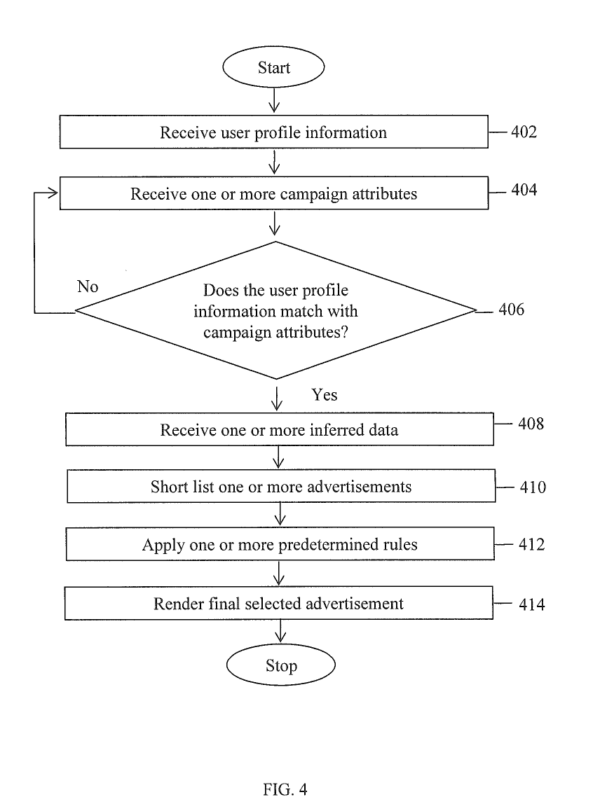

FIG. 4 is a flowchart illustrating a method that facilitates optimized selection and rendering of advertisements on various devices of a user, in accordance with an embodiment of the present invention.

At step 402, user profile information is received. In an embodiment of the present invention, basic information related to the user such as name, age, gender, contact details such as mobile station integrated services digital network (MSISDN) number, city, occupation details etc. corresponding to each of the users devices i.e. personal computer (PC) with internet, (TV) and mobile phone may be obtained. The user profile information may further be modified to include the user's preferences and interests areas.

At step 404, one or more campaign attributes are received. In an embodiment of the present invention, one or more campaign attributes may be determined when advertisement campaigns are created. Advertisement campaigns are created using the information related to the advertisement inventory available on the portal applications across the user's PC, TV and mobile phone. The advertisement inventory may be purchased and the details thereof may be stored in an inventory database. The advertisement inventory details are used by the advertiser for defining the advertisements campaigns. The campaign attributes may represent one or more predetermined criteria that are determined by the advertiser for identifying one or more advertisements for targeted users. In an exemplary embodiment of the present invention, the one or more predetermined criteria may include categorizing advertisements for users between the age group of 25 to 35, categorizing advertisements based on gender, specific income range, location or any other specific trait etc. The information related to campaign attributes, advertiser details, product details and campaign details are stored in a campaign database.

At step 406, a check is performed to determine if the user profile information matches with the one or more campaign attributes. In an embodiment of the present invention, one or more advertisements whose associated campaign attributes match with the user profile information are identified. For example, if the user profile information indicates that the user's age is 25, one or more advertisements associated with campaign attributes for users between the age of 25 and 35 are selected.

If it is determined that the user profile information matches with the one or more campaign attributes, then, at step 408, one or more inferred data is received. The user's basic profile information is updated to an enhanced user profile information using the inferred data. If it is determined that the user profile information does not match with the one or more campaign attributes, then, step 404 is repeated.

At step 410, one or more advertisements are short listed. In an embodiment of the present invention, one or more advertisements may be short listed as targeted advertisements using the enhanced user profile information.

At step 412, one or more predetermined rules are applied on the one or more advertisements. In an embodiment of the present invention, the one or more predetermined rules may be rules defined by the CSP for optimal selection of the final advertisement which is to be rendered on the various devices of the user. In an example, the one or more predetermined rules may include selection of advertisement which may be determined to have maximum return on investment (ROI). In another example, the one or more predetermined rules may be based on cost-per-mill (CPM), cost-per-cost (CPC) etc. For example, if the sports related advertisement is associated with maximum ROI, it is selected as the final advertisement.

At step 414, final selected advertisement is rendered on the various devices. In an embodiment of the present invention, the final selected advertisement is rendered on the advertisement inventory on any of or all of PC, TV and mobile phone of the user. In an exemplary embodiment of the present invention, the advertisement may be rendered when the user is in an interactive session via his various devices. In another exemplary embodiment of the present invention, the advertisement may be rendered when user's devices are in an active but non-interactive mode.

Examples of final advertisements selected for rendering on various devices of the user, in accordance with various embodiments of the present invention is as follows.

### Example 1

A user is identified whose relationship status is married and whose wife is working with a multinational company. The user is a subscriber of an online video store requesting for video rental frequently over a period of four weeks. Further, the user's average video rental requests are a couple of movies over the weekends, but, during the weekends, his minimum number of bookings is found to be three movies beginning from friday evening to sunday evening. Furthermore, the user's recent interest is determined to be thrillers. The advertisements rendered on various devices the user, may include, advertisement for a free “day pass” to an international movie festival on his mobile phone. Further, the advertisement may include advertisement on his TV for downloading unlimited videos on weekends for one time life fees or advertisement on his laptop, connected to internet, of recently released thriller blockbusters with movie trailers

### Example 2

A user is identified to be a fresher starting his professional career. The user is determined to spend more than 2 hours in a day on internet and mobile websites. Rediff.com is his favorite portal. The user frequently accesses details of movies at the cinema at his location both from his laptop and mobile phone. The advertisements rendered on various devices of the user may include receiving trailers of movies released in a week in nearby theaters when the user logs into the internet or switches his TV “on”. The user receives SMS on his mobile phone for coupons available in pizza corner in one of the movie multiplexes near his residence.

The present invention may be implemented in numerous ways including as a apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A method for optimized selection and rendering of advertisements on various device types of a user, the method comprising the steps of:
receiving one or more inferred data related to the user, wherein the inferred data includes static context inferred from user profile information, the user profile information including one or more static details pertaining to the user, and dynamic context inferred from the user's behavior across multiple communication channels using the various device types of the user;
short listing one or more advertisements based on the inferred data;
applying one or more predetermined rules on the short listed advertisements to select a final advertisement; and
rendering the final advertisement on at least one of the various devices types of the user.

2. The method of claim 1 further comprising:
receiving user profile information;
receiving one or more campaign attributes, wherein the campaign attributes represent one or more predetermined criteria for categorizing one or more advertisements;
comparing the user profile information with the one or more campaign attributes;
enhancing the user profile information with one or more inferred data related to the user;
short listing one or more advertisements based on the enhanced user profile information;
applying one or more predetermined rules on the short listed advertisements to select a final advertisement; and
rendering the final advertisement on at least one of the various devices types of the user.

3. The method of claim 1, wherein the one or more static details related to the user comprises name, age, gender, address, mobile station integrated services digital network number (MSISDN), occupation details and any other information related to the user.

4. The method of claim 1, wherein the dynamic context is based on data related to at least one of: one or more requests made by the user via the various device types of the user, current location of the user, user's feedback on an earlier advertisement rendered on at least one of the various device types, and the user's response to an advertisement rendered on the various device types of the user.

5. The method of claim 4, wherein the requests comprise at least one of: browsing a website from a PC, making online purchases using PC, surfing channels in a TV, and making purchases via an IPTV video-on-demand service.

6. The method of claim 1, wherein the dynamic context is based on data obtained by tracking user's different response to same advertisement rendered on the various device types of the user across the multiple communication channels.

7. The method of claim 1, wherein the dynamic context is based on data related to user's rating on an advertisement rendered on at least one of the various device types of the user or user's feedback indicating request for an advertisement different from an advertisement rendered on at least one of the various device types of the user or a combination thereof.

8. The method of claim 1, wherein the multiple communication channels comprises at least one of: internet, wireless network capable of data exchange such as General Packet Radio Service (GPRS), Enhanced Data for Global Evolution (EDGE), High-Speed Packet Access (HSPA), Evolution Data Optimized (EvDO), Long-Term Evolution (LTE), Worldwide Interoperability for Microwave Access (WiMAX), Wireless Fidelity (WiFi), High Speed digital cable, Direct to Home (DTH) TV and Internet Protocol Television (IPTV) and any other type of over the air wireless network.

9. The method of claim 2, wherein the one or more predetermined criteria for categorizing one or more advertisements comprises categorizing advertisements for: users between a specific age group, users residing in a specific location or users with a specific income range, users with a specific trait and a combination thereof.

10. The method of claim 9, wherein the step of comparing the user profile information with the one or more campaign attributes comprises identifying one or more advertisements categorized under one or more predetermined criteria that correspond to the user profile information.

11. The method of claim 9, wherein the one or more predetermined criteria are determined by an advertiser.

12. The method of claim 1 further comprising the step of updating the user profile information with information related to user's preferences and interest areas.

13. The method of claim 1, wherein the one or more predetermined rules comprises: selecting advertisements having maximum return on investment, selecting advertisements based on number of times same or similar advertisements is shown to the user, selecting advertisements based on the deadline for rendering advertisements, selecting advertisements based on cost-per-mill, and selecting advertisements based on cost-per-cost.

14. The method of claim 13, wherein the predetermined rules are determined by a communication service provider.

15. The method of claim 1, wherein the step of rendering the final advertisement on at least one of the various devices types of the user comprises: rendering the advertisements on predetermined space present on web, TV and mobile device portal applications of the user.

16. An optimized advertisement delivery engine for optimized selection and rendering of advertisements on various device types of a user, the optimized advertisement delivery engine comprising:
an inference engine configured to infer data related to the user, wherein the inferred data includes static context inferred from user profile information and dynamic context inferred from the user's behavior across multiple communication channels using the various device types of the user;
an advertisement targeting module configured to short list one or more advertisements based on the inferred data; and
an advertisement selection module configured to select a final advertisement by applying predetermined rules on the short listed advertisements for rendering on at least one of the various device types.

17. The optimized advertisement delivery engine of claim 16, wherein the optimized delivery engine further comprises a data collector module configured to gather data related to the user across the multiple communication channels.

18. The optimized advertisement delivery engine of claim 17 further comprises a metrics and usage database configured to store the gathered data.

19. The optimized advertisement delivery engine of claim 16, wherein the optimized delivery engine further comprises an analytical engine configured to:
analyze the inferred data to determine at least one of: usage of multiple communication channels, and efficiency of a convergence gateway module;
perform trend analysis on advertisement inventory purchases made by the advertisers;
analyze advertisement campaigns published at predetermined space present on web applications provided on the various device types; and
generate one or more reports based on the analysis.

20. The optimized advertisement delivery engine of claim 16, wherein the various device types comprise at least one of: PC, TV, mobile device and any electronic communication device.

21. The optimized advertisement delivery engine of claim 16 further comprising an advertisement publisher module configured to:
receive information related to capabilities and limitations of the various device types;
determine an appropriate format for rendering the final advertisement on the various device types; and
render the advertisement on one or more predetermined space present on web applications provided on the various device types.

22. The optimized advertisement delivery engine of claim 21, wherein the device capabilities and limitations include at least one of: screen size of the device and format supported by the device.

23. A system for optimized selection and rendering of advertisements on various device types of a user, the system comprising:
an application module comprising one or more applications, wherein the application module is configured to facilitate creating one or more campaign attributes, wherein the campaign attributes represent one or more predetermined criteria for categorizing one or more advertisements; and
a multi channel optimized advertisement (MCOA) server in communication with the one or more applications of the application module, wherein the MCOA server comprises an optimized advertisement delivery engine configured to:
short list one or more advertisements based on a comparison of user profile information and the one or more campaign attributes, and further based on one or more inferred data related to the user, wherein the inferred data includes static context inferred from user profile information and dynamic context inferred from the user's behavior across multiple communication channels using the various device types of the user; and
select a final advertisement by applying predetermined rules on the short listed advertisements for rendering on at least one of the various device types.

24. The system of claim 23, wherein the MCOA server further comprises an inventory management module configured to:
facilitate an advertiser to locate one or more predetermined space present on web applications provided on the various device types via an inventory management application in the application module; and
facilitate the advertiser to purchase the one or more predetermined space via the inventory management application.

25. The system of claim 23, wherein the MCOA server further comprises a campaign management module configured to:
facilitate an advertiser to create one or more campaign attributes via a campaign management application in the application module; and
facilitate an advertiser to publish advertisement campaigns on the predetermined space present on web applications provided on the various device types via the campaign management application.

26. The system of claim 23, wherein the MCOA server further comprises a user profile management module configured to:
maintain one or more information related to user comprising name, age, gender, address, mobile station integrated services digital network number (MSISDN), occupation details or any other information related to the user; and
update the one or more information with information related to user preferences and interest areas via a user profile management application.

27. The system of claim 23 further comprises a campaign management database configured to store the one or more campaign attributes.

28. The system of claim 23 further comprises an inventory management database configured to store information related to the one or more predetermined space.

29. The system of claim 23 further comprises a user profile database configured to store the information related to the user.

30. The system of claim 23 further comprises a data access module configured to receive data from the one or more modules of the MCOA server and store the data in a database server.

31. The system of claim 23 further comprises a convergence gateway module configured to:
analyze requests made by the user via the various device types over one or more communication channels;
determine capabilities and limitations of the various device types;
define a set of symbols and rules for creating a markup to present advertisement on the various device types; and
transcode advertisement media from one encoding format to another encoding format supported by the various device types.

32. The system of claim 23, wherein the optimized delivery engine further comprises an advertisement targeting module configured to short list one or more advertisements based on a comparison of user profile information and the one or more campaign attributes, and further based on inferred data related to the user.

33. The system of claim 32, wherein the optimized delivery engine further comprises an advertisement selection module configured to select a final advertisement by applying predetermined rules on the selected advertisements.
